(19) United States
(12) Patent Application Publication
(10) Pub. No.: US 2018/0215121 A1
(43) Pub. Date: Aug. 2, 2018

(54) Striped Multilayer Film

(71) Applicant: Dow Global Technologies LLC

(72) Inventors: Patrick Chang Dong Lee, S. Burlington, VA (US); Bruce Menning, Midland, MI (US); Yijian Lin, Manvel, TX (US); Robert E. Wrisley, Clare, MI (US); Kurt W. Olson, Midland, MI (US); Joseph Dooley, Midland, MI (US)

(21) Appl. No.: 15/322,500

(22) PCT Filed: Jun. 29, 2015
(86) PCT No.: PCT/US15/38307

§ 371 Date: Dec. 28, 2016

Related U.S. Application Data
(60) Provisional application No. 62/019,032, filed on Jun. 30, 2014.

(51) Int. Cl. B32B 3/18; B32B 5/14; B32B 27/08; B32B 27/20; B32B 27/32; B32B 27/30; B32B 27/28; B32B 27/34

(52) U.S. Cl. CPC B32B 3/18; B32B 5/142; B32B 27/08; B32B 27/20; B32B 27/32; B32B 27/306; B29C 47/0021; B32B 27/34; B32B 2250/05; B32B 2250/24; B32B 2250/42; B32B 2270/00; B32B 2439/70; B32B 27/285

(57) ABSTRACT

The present disclosure provides a multilayer film. The multilayer film includes a core component comprising from 10 to 50,000 alternating stripes of a layer A and a layer B. Layer A has a width from 10 μηη to 10 mm and comprises a film material. Layer B has a width from 10 μm to 10 mm and comprises a transport material. The core component has a CO₂ transmission rate (CO₂TR) from 50,000 to 300,000 cc-mil/m²/24 hour/atm and water transmission rate (WVTR) from 50 to 500 g-mil/m²/24 hour.

### BACKGROUND

The present disclosure is directed to a multilayer film with a core component composed of striped alternating layers, the multilayer film suitable for MAP.

Improving the quality and the shelf life of fresh produce and fresh cut produce has long been an objective of the food industry. Technologies such as controlled atmosphere storage (CA), modified atmosphere packaging (MAP), and ripening control technologies such as ethylene absorbers and ethylene antagonists (1-MCP) have been developed and are selectively used to achieve extended produce shelf life and improved produce quality. Understanding of biological variation such as fruit type, variety, maturity, growing region, and climatic response are key when selecting the appropriate technology for packaging, storing, and transporting produce.

Most produce incurs significant damage from fungus and mold when the moisture level inside a package is too high and condensation occurs. Most produce incurs significant damage when the moisture level inside a package is too low and dehydration resulting in shrivel occurs. Most produce generates carbon dioxide (CO₂) as they ripen and consume oxygen (O₂). Most produce incurs damage when the CO₂ level in the package becomes too high (typically above 5%). Thus, the art recognizes the challenge in producing a MAP-package for produce that achieves desired levels of transmission for four gasses—O₂, CO₂, ethylene, and 1-MCP and simultaneously maintains suitable water permeability.

Conventional monolithic MAP has shortcomings. Conventional MAP typically provide one desired permeation feature at the sacrifice of other permeation or transport features. MAP films made from polymers with high water solubility such as nylon or polylactic acid have high water transmission rates and are often used for produce that is moisture sensitive. These polymers typically are good barriers to other gases such as carbon dioxide, oxygen, ethylene, and 1-MCP which can be harmful in some the applications. Moreover, these high water solubility polymers are expensive relative to polyolefins.

On the other hand, MAP films made from polyolefins typically have good transmission of ethylene and carbon dioxide but have low water transmission rate. The olefin polymers are typically low cost and also offer good toughness, transparency, heat sealing, and processability.

Perforation also has shortcomings. Although perforation (either micro-perforation or macro-perforation) can increase the oxygen transmission into the produce package, it requires additional processing steps and additional processing equipment, therefore adding energy and cost to the film. In addition, perforations may increase oxygen transmission for a film but they do not provide significant amounts of water transport unless the perforations are very large (˜3 microns or greater). Perforations also move less carbon dioxide than oxygen at equivalent driving forces due to the higher molecular weight and slower diffusion of carbon dioxide (Graham's law). Perforations can create a natural carbon dioxide accumulation in produce packages made from low carbon dioxide transport films such as nylon, for example.

A need exists for a film capable of balancing transmission of one or more gasses in conjunction with maintaining water permeability suitable for produce packaging applications. A need further exists for a produce packaging film with suitable CO₂ transmission, the ability to transmit ethylene and 1-MCP, while simultaneously providing controlled water permeability to enable the benefits of the MAP environment.

### SUMMARY

The present disclosure is directed to a multilayer film with a core component composed of stripes of alternating layers. The striped structure provides the multilayer film with improved permeability properties. By coextruding layers in a striped arrangement, as opposed to a stacked arrangement, the present film has an unexpected combination of improved CO₂ transmission and improved water permeability.

In an embodiment a multilayer film is provided. The multilayer film includes a core component comprising from 10 to 50,000 alternating stripes of a layer A and a layer B. Layer A has a width from 10 μm to 10 mm and comprises a film material. Layer B has a width from 10 μm to 10 mm and comprises a transport material. The core component has a CO₂ transmission rate (CO₂TR) from 50,000 to 300,000 cc-mil/m²/24 hour/atm and water transmission rate (WVTR) from 50 to 500 g-mil/m²/24 hour.

### BRIEF DESCRIPTION OF THE DRAWING

The accompanying Figures together with the following description serve to illustrate and provide a further understanding of the disclosure and its embodiments and are incorporated in and constitute a part of this specification.

FIG. 1 is a schematic diagram illustrating a stacked multilayer film.

FIG. 2 is a schematic representation illustrating a striped multilayer film.

FIG. 3 is a schematic representation of a striped multilayer film exiting an extruder.

FIG. 4 is a schematic representation of a coextrusion device in accordance with an embodiment of the present disclosure.

FIG. 5 is a front elevation view of a coextruded structure having stripes of alternating layer A and layer B in accordance with an embodiment of the present disclosure.

FIG. 6 is a graph of WVTR versus content of layer B (%) present in the core component.

FIG. 7 is a graph of CO₂TR versus content of layer B (%) present in the core component.

### DEFINITIONS

“Blend”, “polymer blend” and like terms mean a composition of two or more polymers. Such a blend may or may not be miscible. Such a blend may or may not be phase separated. Such a blend may or may not contain one or more domain configurations, as determined from transmission electron spectroscopy, light scattering, x-ray scattering, and any other method known in the art. Blends are not laminates, but one or more layers of a laminate may contain a blend.

The term “composition,” as used herein, refers to a mixture of materials which comprise the composition, as well as reaction products and decomposition products formed from the materials of the composition.

The terms “comprising,” “including,” “having,” and their derivatives, are not intended to exclude the presence of any additional component, step or procedure, whether or not the same is specifically disclosed. In order to avoid any doubt, all compositions claimed through use of the term “comprising” may include any additional additive, adjuvant, or compound, whether polymeric or otherwise, unless stated to the contrary. In contrast, the term, “consisting essentially of” excludes from the scope of any succeeding recitation any other component, step or procedure, excepting those that are not essential to operability. The term “consisting of” excludes any component, step or procedure not specifically delineated or listed.

An “ethylene-based polymer” is a polymer that contains more than 50 mole percent polymerized ethylene monomer (based on the total amount of polymerizable monomers) and, optionally, may contain at least one comonomer.

As used herein, the term “film”, including when referring to a “film layer” in a thicker article, unless expressly having the thickness specified, includes any thin, flat extruded or cast thermoplastic article having a generally consistent and uniform thickness up to about 0.254 millimeters (10 mils). “Layers” in films can be very thin, as in the cases of nanolayers discussed in more detail below.

As used herein, the term “sheet”, unless expressly having the thickness specified, includes any thin, flat extruded or cast thermoplastic article having a generally consistent and uniform thickness greater than “film”, generally at least 0.254 millimeters thick and up to about 7.5 mm (295 mils) thick. In some cases sheet is considered to have a thickness of up to 6.35 mm (250 mils).

Either film or sheet, as those terms are used herein can be in the form of shapes, such as profiles, parisons, tubes, and the like, that are not necessarily “flat” in the sense of planar but utilize A and B layers according to the present disclosure and have a relatively thin cross section within the film or sheet thicknesses according to the present disclosure.

The term “interpolymer,” as used herein, refers to polymers prepared by the polymerization of at least two different types of monomers. The generic term interpolymer thus includes copolymers (employed to refer to polymers prepared from two different types of monomers), and polymers prepared from more than two different types of monomers.

“Melting Point” as used herein is typically measured by the DSC technique for measuring the melting peaks of polyolefins as described in U.S. Pat. No. 5,783,638. It should be noted that many blends comprising two or more polyolefins will have more than one melting peak; many individual polyolefins will comprise only one melting peak.

A “nanolayer structure,” as used herein, is a multilayer structure having two or more layers each layer with a thickness from 1 nanometer to 900 nanometers.

An “olefin-based polymer,” as used herein is a polymer that contains more than 50 mole percent polymerized olefin monomer (based on total amount of polymerizable monomers), and optionally, may contain at least one comonomer. Nonlimiting examples of olefin-based polymer include ethylene-based polymer and propylene-based polymer.

The term “polymer,” as used herein, refers to a polymeric compound prepared by polymerizing monomers, whether of the same or a different type. The generic term polymer thus embraces the term homopolymer (employed to refer to polymers prepared from only one type of monomer, with the understanding that trace amounts of impurities can be incorporated into the polymer structure), and the term interpolymer as defined hereinafter. The term polymer includes trace amounts of catalyst residue that may be incorporated into and/or within the polymer.

A “propylene-based polymer” is a polymer that contains more than 50 mole percent polymerized propylene monomer (based on the total amount of polymerizable monomers) and, optionally, may contain at least one comonomer.

The numerical ranges disclosed herein include all values from, and including, the lower value and the upper value. For ranges containing explicit values (e.g., 1 or 2, or 3 to 5, or 6, or 7) any subrange between any two explicit values is included (e.g., 1 to 2; 2 to 6; 5 to 7; 3 to 7; 5 to 6; etc.).

Unless stated to the contrary, implicit from the context, or customary in the art, all parts and percents are based on weight, and all test methods are current as of the filing date of this disclosure.

### DETAILED DESCRIPTION

The present disclosure provides a multilayer film. In an embodiment, a coextruded multilayer film is provided and includes a core component. The core component includes from 10 to 50,000 alternating stripes of a layer A and a layer B. Layer A has a width from 10 μm to 10 mm and includes a film material. Layer B has a width from 10 μm to 10 mm and includes a transport material. The core component has a CO₂ transmission rate (CO₂TR) from 50,000 to 300,000 cc-mil/meter² (m²)/24 hour (hr)/atmosphere (atm) and a water transmission rate (WVTR) from 50 to 500 g-mil/m²/24 hour.

1. Core Component

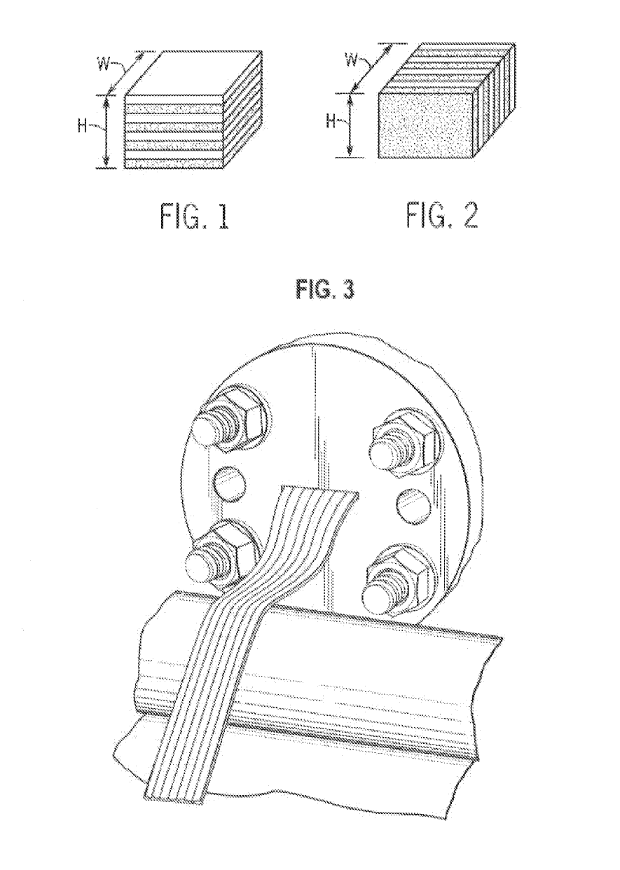

The core component includes from 10 to 50,000 alternating stripes of layer A and layer B. The term “stripes” (or “striped”) is a multilayer film structure wherein the film layers are disposed side-by-side along the width dimension of the film. A striped multilayer film is distinct from, and excludes a multilayer film with a “stacked” layer structure. FIG. 1 shows a multilayer film with a stacked layer structure. The stacked layers are disposed one on top of each other along the width dimension, W, of the FIG. 1 multilayer film structure. When a stacked multilayer film is viewed from a top plan view, only a single film layer (i.e., the uppermost film layer) is seen. FIG. 2 shows a multilayer film with a striped layer structure. The striped layers are disposed side-by-side along the width dimension, W, of the FIG. 2 film. When a striped multilayer film is viewed from a top plan view, the plurality of film layers is seen. FIG. 3 shows a striped multilayer film exiting an extruder.

2. Layer A

The core component of the present multilayer film includes from 10 to 50,000 alternating stripes of layer A and layer B. Layer A is composed of one or more film materials. A “film material” is a polymer that imparts desired film properties to the core component. Nonlimiting examples of film properties include tensile (strength, elongation), impact (strength, resistance), tear (Elmendorf), and combinations thereof.

The layer A film material can be an olefin-based polymer (such as an ethylene-based polymer, a propylene-based polymer), an ethylene/diene interpolymer, an ethylene acrylic acid polymer (EAA), an ethylene-vinyl acetate polymer (EVA), an ethylene ethyl acrylate polymer (EEA), ethylene methyl acrylate polymer (EMA), ethylene n-butyl acrylate polymer (EnBA), an ethylene methacrylic acid polymer (EMAA), copolymers of polyesters or amorphous polyester such as with PETG available from Eastman Chemicals as EASTAR™ copolyester 6763, polylactic acid (PLA), homopolymer polyamides such as Nylon 6 or Nylon 66 or copolymer polyamides such as Nylon 6/66, an ionomer, and combinations thereof.

In an embodiment, the layer A film material includes an ethylene-based polymer. The ethylene-based polymer can be an ethylene homopolymer or an ethylene copolymer. The ethylene based polymer has a melt index from 0.01 g/10 minutes (min) to 35 g/10 min.

In an embodiment, the ethylene-based polymer is a thermoplastic ethylene-based polymer. Nonlimiting examples of suitable thermoplastic ethylene-based polymer includes high pressure, free-radical low density polyethylene (LDPE), and ethylene-based polymers prepared with Ziegler-Natta catalysts, including high density polyethylene (HDPE) and heterogeneous linear low density polyethylene (LLDPE), ultra low density polyethylene (ULDPE), and very low density polyethylene (VLDPE), as well as multiple-reactor ethylenic polymers (“in reactor” blends of Ziegler-Natta PE and metallocene PE, such as products disclosed in U.S. Pat. No. 6,545,088 (Kolthammer et al.); U.S. Pat. No. 6,538,070 (Cardwell et al.); U.S. Pat. No. 6,566,446 (Parikh et al.); U.S. Pat. No. 5,844,045 (Kolthammer et al.); U.S. Pat. No. 5,869,575 (Kolthammer et al.); and U.S. Pat. No. 6,448,341 (Kolthammer et al.)). Commercial examples of linear ethylene-based polymers include ATTANE™ Ultra Low Density Linear Polyethylene Copolymer, DOWLEX™ Polyethylene Resins, and FLEXOMER™ Very Low Density Polyethylene, all available from The Dow Chemical Company.

In an embodiment, the ethylene-based polymer is an ethylene-based elastomer. Nonlimiting examples of suitable ethylene-based elastomer include homogeneous metallocene-catalyzed, ethylene-based elastomers such as AFFINITY™ polyolefin plastomers and ENGAGE™ polyolefin elastomers, both available from The Dow Chemical Company; VISTAMAX™ polymers available from ExxonMobil Chemical Company; olefin block copolymers, such as polyethylene olefin block copolymers (PE-OBC) such as INFUSE™ resins, available from The Dow Chemical Company.

In an embodiment, the layer A includes a linear low density polyethylene (LLDPE). Linear low density polyethylene (“LLDPE”) comprises, in polymerized form, a majority weight percent of ethylene based on the total weight of the LLDPE. In an embodiment, the LLDPE is an interpolymer of ethylene and at least one ethylenically unsaturated comonomer. In one embodiment, the comonomer is a C₃-C₂₀ α-olefin. In another embodiment, the comonomer is a C₃-C₈ α-olefin. In another embodiment, the C₃-C₈ α-olefin is selected from propylene, 1-butene, 1-hexene, or 1-octene. In an embodiment, the LLDPE is selected from the following copolymers: ethylene/propylene copolymer, ethylene/butene copolymer, ethylene/hexene copolymer, and ethylene/octene copolymer. In a further embodiment, the LLDPE is an ethylene/octene copolymer.

The LLDPE has a density in the range from 0.890 g/cc to less than 0.940 g/cc, or from 0.91 g/cc to 0.935 g/cc. The LLDPE has a melt index (MI) from 0.1 g/10 min to 10 g/10 min, or from 0.5 g/10 min to 5 g/10 min. LLDPE is distinct from other types of ethylene-based polymer such as HDPE which has a density of at least 0.94 g/cc, or from at least 0.94 g/cc to 0.98 g/cc.

LLDPE can be produced with Ziegler-Natta catalysts, or single-site catalysts, such as vanadium catalysts and metallocene catalysts. In an embodiment, the LLDPE is produced with a Ziegler-Natta type catalyst. LLDPE is linear and does not contain long chain branching and is different than low density polyethylene (“LDPE”) which is branched or heterogeneously branched polyethylene. LDPE has a relatively large number of long chain branches extending from the main polymer backbone. LDPE can be prepared at high pressure using free radical initiators, and typically has a density from 0.915 g/cc to 0.940 g/cc.

In an embodiment, the LLDPE is a Ziegler-Natta catalyzed ethylene and octene copolymer and has a density from 0.91 g/cc, or 0.929/cc to 0.93 g/cc. The LLDPE has a crystallinity from 40% to 50%, or 47%. Nonlimiting examples of suitable Ziegler-Natta catalyzed LLDPE are polymers sold under the tradename DOWLEX, available from The Dow Chemical Company, Midland, Mich.

In an embodiment, the LLDPE is a single-site catalyzed LLDPE (“sLLDPE”). As used herein, “sLLDPE” is a LLDPE polymerized using a single site catalyst such as a metallocene catalyst or a constrained geometry catalyst. A “metallocene catalyst” is a catalyst composition containing one or more substituted or unsubstituted cyclopentadienyl moiety in combination with a Group 4, 5, or 6 transition metal. Nonlimiting examples of suitable metallocene catalysts are disclosed in U.S. Pat. No. 5,324,800, the entire content of which is incorporated herein by reference. A “constrained geometry catalyst” comprises a metal coordination complex comprising a metal of groups 3-10 or the Lanthanide series of the Periodic Table and a delocalized pi-bonded moiety substituted with a constrain-inducing moiety, said complex having a constrained geometry about the metal atom such that the angle at the metal between the centroid of the delocalized, substituted pi-bonded moiety and the center of at least one remaining substituent is less than such angle in a similar complex containing a similar pi-bonded moiety lacking in such constrain-inducing substituent, and provided further that for such complexes comprising more than one delocalized, substituted pi-bonded moiety, only one thereof for each metal atom of the complex is a cyclic, delocalized, substituted pi-bonded moiety. The constrained geometry catalyst further comprises an activating cocatalyst. Nonlimiting examples of suitable constrained geometry catalysts are disclosed U.S. Pat. No. 5,132,380, the entire content of which is incorporated by reference herein.

In one embodiment, the sLLDPE has a density of less than 0.940 g/cc or from 0.90 g/cc to less than 0.94 g/cc. In one embodiment, the sLLDPE has a melt index from 0.5 g/10 min to 3 g/10 min, or from 0.5 g/10 min to 2 g/10 min. The sLLDPE, may be unimodal or multimodal (i.e., bimodal). A “unimodal sLLDPE” is a LLDPE polymer prepared from one single-site catalyst under one set of polymerization conditions. Nonlimiting examples of suitable unimodal sLLDPE include those sold under the trade names EXXACT and EXCEED, available from the ExxonMobil Chemical Company, Houston, Tex.; and AFFINITY available from The Dow Chemical Company, Midland, Mich.

Not wishing to be bound by any particular theory, it is believed that single-site catalyzed LLDPE is homogeneously branched whereas Ziegler-Natta catalyzed LLDPE is heterogeneously branched. With homogeneously branched LLDPE, the comonomer is randomly distributed within a given interpolymer molecule and substantially all of the interpolymer molecules have the same ethylene/comonomer ratio within that interpolymer. On the other hand, heterogeneously branched LLDPE has a distribution of branching, including a branched portion (similar to a very low density polyethylene), and a substantially linear portion (similar to linear homopolymer polyethylene).

For example, a Ziegler-Natta catalyzed LLDPE, such as DOWLEX 2045 (an ethylene/octene copolymer having a melt index (I₂) of about 1 g/10 min, a density of about 0.92 g/cc, a melt flow ratio (I₁₀/I₂) of about 7.93 and a molecular weight distribution (M_{w}/Mₙ) of about 3.34), contains heterogeneous short chain branching equal to the number of carbons of the ethylenically unsaturated comonomer minus two. The comonomer is intermolecularly distributed in a characteristic way, whereby a fraction of the molecules are free of, or otherwise devoid of, comonomer. The comonomer-free fraction is further characterized by having a high molecular weight compared to the branched fraction of the sample. Upon crystallization, the comonomer-free fraction forms large crystals due to the absence of chain defects that interfere with the chain folding process. Large crystals are desirable for barrier properties, as gas molecules (such as oxygen for example) cannot penetrate the large crystals. Thus, at a given crystallinity, a heterogeneous crystal size distribution provides greater gas barrier capability compared to homogeneously branched polyethylene.

Homogeneously branched LLDPE, on the other hand, may or may not have a comonomer-free fraction. Absent a comonomer-free fraction, homogeneously-branched LLDPE exhibits a homogeneous crystal size distribution. When the comonomer-free fraction is present, the molecular weight of the comonomer-free fraction is low compared to the branched fraction, resulting in a small crystal size. Accordingly, crystals in a homogeneously-branched LLDPE are substantially the same size, the crystals being smaller than the crystals found in a heterogeneously branched LLDPE with the same copolymer and copolymer content. The smaller, homogeneously distributed crystals provide less gas barrier capability when compared to the larger crystals of the heterogeneously-branched LLDPE. Consequently, heterogeneously-branched LLDPE (i.e., Ziegler-Natta catalyzed LLDPE) has greater gas barrier capability when compared to homogeneously-branched LLDPE (i.e., single-site catalyzed LLDPE).

Nonlimiting examples of suitable LLDPE include DOWLEX 2517 and DOWLEX 2035 each available from The Dow Chemical Company Midland, Mich., USA.

The LLDPE may comprise two or more of the foregoing embodiments.

In an embodiment, layer A includes a blend of LLDPE and one or more additional polymers. Nonlimiting examples of suitable blend components for layer A include ethylene-based polymers, propylene-based polymers, and combinations thereof.

In an embodiment, the layer A film material is a propylene-based polymer. The propylene-based polymer can be a propylene homopolymer, a propylene copolymer, a blend of two or more propylene homopolymers or two or more copolymers, and a blend of one or more homopolymer with one or more copolymer. The propylene-based polymer can be substantially isotactic propylene homopolymer, random propylene copolymers, a graft propylene copolymers or a block propylene copolymer such as polypropylene olefin block copolymers (PP-OBC) such as INTUNE™ resins available from The Dow Chemical Company.

In an embodiment, the propylene-based polymer is a propylene copolymer including at least 85, or at least 87, or at least 90, mole percent units derived from propylene. The remainder of the units in the propylene copolymer is derived from units of ethylene and/or an α-olefin having up to about 20, preferably up to 12 and more preferably up to 8, carbon atoms. The α-olefin is preferably a C4-20 linear, branched or cyclic α-olefin as described above.

In an embodiment, the propylene-based polymer has an MFR (measured in 10 g/min at 230° C./2.16 kg) is at least about 0.5, or at least about 1.5, or at least about 2.5 g/10 min and less than or equal to about 25, or less than or equal to about 20, or less than or equal to about 18 g/10 min.

Non-limiting examples of suitable propylene-based polymer include a propylene impact copolymer (such as Braskem Polypropylene T702-12N); propylene homopolymer (such as Braskem Polypropylene H502-25RZ); propylene random copolymer (such as Braskem Polypropylene R751-12N)

Other suitable propylene-based polymers include homogeneous propylene-based elastomers (such as include VERSIFY™ performance polymers, available from The Dow Chemical Company), and VISTAMAX™ polymers available from ExxonMobil Chemical Company, and PROFAX™ polymers available from Lyondell Basell Industries, e.g., PROFAX™ SR-256M, which is a clarified propylene copolymer resin with a density of 0.90 g/cc and a MFR of 2 g/10 min, PROFAX™ 8623, which is an impact propylene copolymer resin with a density of 0.90 g/cc and a MFR of 1.5 g/10 min.

Other suitable propylene-based polymers include CATALLOY™ in-reactor blends of polypropylene (homo- or copolymer) with one or more of propylene-ethylene or ethylene-propylene copolymer (all available from Basell, Elkton, Md.), Shell's KF 6100 propylene homopolymer; Solvay's KS 4005 propylene copolymer; and Solvay's KS 300 propylene terpolymer. Furthermore, INSPIRE™ D114, which is a branched impact copolymer polypropylene with a melt flow rate (MFR) of 0.5 dg/min (230° C./2.16 kg) and a melting point of 164° C. would be a suitable polypropylene. In general, suitable high crystallinity polypropylene with high stiffness and toughness include but are not limited to INSPIRE™ 404 with an MFR of 3 g/10 min, and INSPIRE™ D118.01 with a melt flow rate of 8.0 g/10 min (230° C./2.16 kg), (both also available from Braskem).

Propylene polymer blend resins can also be used where polypropylene resins as described above can be blended or diluted with one or more other polymers, including polyolefins as described below, to the extent that the other polymer is (i) miscible or compatible with the polypropylene, (ii) has little, if any, deleterious impact on the desirable properties of the polypropylene, e.g., toughness and modulus, and (iii) the polypropylene constitutes at least about 55, preferably at least about 60, more preferably at least about 65 and still more preferably at least about 70, weight percent of the blend. The propylene polymer can be also be blended with cyclic olefin copolymers such as Topas 6013F-04 cyclic olefin copolymer available from Topas Advanced Polymers, Inc. with preferred amounts when used at least about 2, preferably 4, and more preferably 8 weight percent up to and including to 40, preferably 35 and more preferably 30 weight percent. In general, propylene polymer resins for layer A can comprise an impact modifier such as ethylene octene plastomers or elastomers such as AFFINITY™ PL 1880G, or ENGAGE™ 8100G, and ENGAGE™ 1850G available from The Dow Chemical Company. In general, these are used in amounts at least of about 2 weight percent, preferably at least about 5 and more preferably at least about 8 weight percent and preferably less than about 45 weight percent, preferably less than about 35 weight percent and more preferably less than about 30 weight percent. Other candidate impact modification or blend resins are ethylene/propylene rubbers (optionally blended with polypropylene in-reactor) and one or more block composites as described herein. Combinations of impact modifiers of different types may also be used.

3. Layer B

The core component of the present multilayer film includes from 10 to 50,000 alternating stripes of layer A and layer B. Layer B is composed of one or more transport materials. A “transport material” is a polymer that imparts to the core component a WVTR of greater than 50 g-mil/m²/day and a CO₂TR greater than 50,000 cc-mil/m²/day/atm for 1 mil multilayer film with 50 vol % layer B.

The layer B transport material can be one or more polymers selected from ethylene-based polymer, ethylene vinyl acetate (EVA) copolymer for example ELVAX® 3135, ethylene vinyl acetate carbon monoxide terpolymer (EVA-CO) such as ELVALOY® resins, ethylene ethyl acrylate (EEA), ethylene methyl acrylate (EMA), ethylene butyl acrylate (EBA), polycarbonate, thermoplastic polyurethanes (TPU), polyethylene oxide copolymer (PEO), polycaprolactone (PCL), polyether based materials, such as polytetramethylene oxide (PTMO), and polyether block amide, polyvinyl ester such as polyvinyl acetate, and blends thereof.

In an embodiment, layer B transport material may be any polymer listed above that is grafted with a functional species such as maleic anhydride or glycidyl methacrylate. A nonlimiting example of a suitable functionalized polymer for the layer B transport material is ethylene methyl acrylate graft maleic anhydride resin sold as BYNEL® 3860.

In an embodiment, layer B is composed of a polyether block amide. Nonlimiting examples of suitable polyether block amide are those sold under the tradename PEBAX, which is commercially available from Arkema, Inc.

Other nonlimiting examples of polymers suitable for the layer B transport material are shown in Table 1 below.

TABLE 1

| Material | WVTR | CO₂ TR |
|---|---|---|
| Elite 5400G | 18.6 | |
| Elvax 3135 (12% VA) | 73 | 78,600 |
| Nylon 6 | 250-340 | 155-186 |
| Metallecene PE (Affinity, | 16-78 | 31,000-108,000 |
| Elite) | | |
| Polycarbonate | 171 | 16,700 |
| PMMA | 124 | |
| Polyurethane elastomer | 620-1160 | 7,000-25,600 |
| PVC | 78-465 | 4,700-186,000 |
| PolyEthyleneOxide | | 153,000 |
| copolymer | | |
| Poly(dimethylsiloxane) | | 76,000 > 300,000 |
| Polylactic Acid | 354 | 10,500 |
| Polybutlene succinate | 890 | ~2,500 |

4. Layer C

The core component may include an optional layer C. In an embodiment, the core component of the present multilayer film includes from about 10 to 50,000 alternating stripes of layer A, layer B, and layer C. Layer C is composed of one or more tie materials. A “tie material” is a polymer that improves adhesion between layer A and layer B. Layers A, B, and C may be arranged in any desired sequence, including, but not limit to, A-B, A-B-C, A-B-A-C, A-B-C-A, A-B-B-C, etc.

Nonlimiting examples of suitable polymers for the tie material include ethylene copolymers, olefin block copolymers (OBC) of ethylene or propylene such as PE-OBC sold as INFUSE or PP-OBC sold as INTUNE by The Dow Chemical Company, polar ethylene copolymers such as copolymers with vinyl acetate, acrylic acid, methyl acrylate, and ethyl acrylate; ionomers; maleic anhydride-grafted ethylene polymers and copolymers; blends of two or more of these; and blends with other polymers comprising one or more of these.

5. Particulate Filler Material

In an embodiment, one, some, or all of layer A, layer B, and layer C can be filled with a particulate fill material. In an embodiment, the layer A may be filled. For example, the layer A may be a blend of a first LLDPE, a second LLDPE (different than the first LLDPE), and a composite that is an LLDPE ethylene-based polymer (such as a third LLDPE different than the first LLDPE and the second LLDPE) and a particulate filler material.

Nonlimiting examples of suitable particulate filler material include calcium carbonate (CaCO₃), various kinds of clay, silica (SiO₂), alumina, barium sulfate, sodium carbonate, talc, magnesium sulfate, titanium dioxide, zeolites, aluminum sulfate, cellulose-type powders, diatomaceous earth, magnesium sulfate, magnesium carbonate, barium carbonate, kaolin, mica, carbon, calcium oxide, magnesium oxide, aluminum hydroxide, pulp powder, wood powder, cellulose derivatives, polymer particles, chitin, and chitin derivates, and blends thereof. Volume percent of the particulate filler material can be from 10 vol % up to percolation limit or close to 70 vol % depending on particle size, particle size distribution and filler aspect ratio.

In an embodiment, the layer B could be a blend of a material from the list for layer B as given above and a suitable filler. For example, layer B may comprise a polyolefin elastomer such as ENGAGE™, an optional highly functional resin for example EVA such as ELVAX 3135 and a sufficient loading of suitable filler such as CaCO₃.

In an embodiment, both layers A and B include the particulate filler material. It is preferable to use filler in layer A in a manner sufficient to maintain physical properties such as not using fillers of very large size or in very high amount.

6. Core Component

The core component of the present multilayer film includes from 10 to 100,000 alternating stripes of layer A and layer B and optional layer C.

In an embodiment, the core component includes from 20, or 28, or 30, or 50, or 100, or 200 to 1000, or 2000, or 5,000, or 10,000, or 20,000, or 50,000, or 100,000 alternating layers of layer A and layer B. The width of layer A and layer B (and optional layer C) can be the same or different. In an embodiment, the width of layer A is the same, or substantially the same, as the width of layer B. Layer A has a width from 10, or 20, or 30, or 50 micrometer to 1, or 2, or 5, or 7, or 8, or 10 mm. Layer B has a width from 10, or 20, or 30, or 50 micrometer to 1, or 2, or 5, or 7, or 8, or 10 mm.

The number of A layers and B layers present in the core component can be the same or different. In an embodiment, the A:B layer ratio (number of A layers to the number of B layers) is from 90:10, or 75:25, or 50:50 to 25:75, or 10:90.

In an embodiment, the core component includes 2,500 alternating layers of layer A and layer B and the core component has an A:B layer ratio from 50:50, or 25:75 to 10:90. Layer A has a width from 0.1 to 1.0 mm.

The core component may be produced with a multilayer coextrusion apparatus as illustrated in FIG. 3. The process to make the multilayer coextruded film may be either a blown film or a cast film process. The multilayer film can be oriented in either machine direction (MD) or transverse direction (TD) or in both directions from 1.1 up to 10 times the original dimensions.

In an embodiment, the core component has a total thickness from 2.5 micrometers to 250 micrometers (0.1 mil to 10.0 mil). In a further embodiment, the core component has a thickness from 2.5, or 5, or 7.5, or 10, or 12.5 to 20, or 25, or 37.5, or 50, or 75, or 125, or 200, or 250 micrometers (0.1 mil, or 0.2 mil, or 0.3 mil, or 0.4 mil, or 0.5 mil, to 0.8 mil, or 1.0 mil, or 1.5 mil, or 2.0 mil, or 3.0 mil, or 5.0 mil, or 7.9 mil, or 10.0 mil).

In an embodiment, the core component of the multilayer film includes layer A having a width from 0.05 mm to 0.5 mm; and layer B having a width from 0.05 mm to 0.5 mm.

In an embodiment, the core component has a thickness from 0.5 mil to 4.0 mil and includes from 10 to 100 stripes of alternating layers A and layers B. Layer A has a width from 1.0 mm to 10 mm and includes a blend that is a first LLDPE, a second LLDPE (different than the first LLDPE), and a composite that is an LLDPE (a third LLDPE different than the first LLDPE and the second LLDPE) and a particulate filler material such as CaCO₃. Layer B has a width from 1.0 mm to 10.0 mm and includes a polyether block amide. The core component has one, some, or all of the following properties:

(i) a water vapor transmission rate (WVTR) from 50, or 100, or 150, or 200, or 250 to 300, 0r 350, or 400, or 450, or 500 g-mil/m²/24 hour; and

(ii) a carbon dioxide transmission rate (CO₂TR) from 50,000, or 100,00, or 150,000 to 200,000, or 250,000, or 300,000 cc-mil/m²/24 hour/atm.

The core component may comprise two or more embodiments disclosed herein.

7. Skin Layers

In an embodiment, the multilayer film includes at least one skin layer. In a further embodiment, the multilayer film includes two skin layers. The skin layers are outermost layers, with a skin layer on each side of the core component. The skin layers oppose each other and sandwich the core component. The skin layers can be striped layers or stacked layers. In an embodiment, the skin layers are striped layers. The composition of each individual skin layer may be the same or different as the other skin layer. Nonlimiting examples of suitable polymers that can be used as skin layers include ethylene-based polymers, propylene-based polymers, polyethylene oxide, polycaprolactone, polyamides, polyesters, copolymers of polyester, polyvinylidene fluoride, polystyrene, polycarbonate, polymethylmethacrylate, polyamides, ethylene-co-acrylic acid copolymers, polyoxymethylene and blends of two or more of these; and blends with other polymers comprising one or more of these.

In an embodiment, one or both skin layers may include the particulate filler material as previously described herein.

In an embodiment, the skin layers include a blend that is a first LLDPE, a second LLDPE (different than the first LLDPE), and a composite that is an LLDPE (a third LLDPE different than the first LLDPE and the second LLDPE) and a filler such as CaCO₃.

In an embodiment, the skin layers are composed of ELITE™ or AFFINITY™ polyethylene resin or similar.

In an embodiment, the skin layers are composed of VERSIFY™ propylene based polymer.

In an embodiment, the skin layers are composed of the same blend that is used in layer A. The blend in layer A and the skin layers includes a first LLDPE, a second LLDPE (different than the first LLDPE), and a composite that is an LLDPE (a third LLDPE different than the first LLDPE and the second LLDPE) and a particulate filler material such as CaCO₃.

The thickness of each skin layer may be the same or different. The two skin layers have a thickness from 5%, or 7%, or 10%, or 15% to 20%, or 30%, or 35% the total volume of multilayer film.

In an embodiment, the thickness of the skin layers is the same. The two skin layers with the same thickness are present in multilayer film in the volume percent set forth above. For example, a multilayer film with 35% skin layer indicates each skin layer is present at 17.5% the total volume of the multilayer film.

8. Optional Other Layer

The skin layers may be in direct contact with the core component (no intervening layers). Alternatively, the multilayer film may include one or more intervening layers between each skin layer and the core component. The present multilayer film may include optional additional layers. The optional layer(s) may be intervening layers (or internal layers) located between the core component and the skin layer(s). Such intervening layers (or internal layers) may be single, repeating, or regularly repeating layer(s). Such optional layers can include the materials that have (or provide) sufficient adhesion and provide desired properties to the films or sheet, such as tie layers, low barrier layers, skin layers, etc.

Nonlimiting examples of suitable polymers that can be employed as tie or adhesive layers include: olefin block copolymers (OBC) that are polyethylene based (PE-OBC) such as INFUSE™ or polypropylene based (PP-OBC) such as INTUNE™ (sold by The Dow Chemical Company), polar ethylene copolymers such as copolymers with vinyl acetate, acrylic acid, methyl acrylate, and ethyl acrylate; ionomers; maleic anhydride-grafted ethylene polymers and copolymers; blends of two or more of these; and blends with other polymers comprising one or more of these.

As noted above, the multilayer film according to the present disclosure can be advantageously employed as a component in thicker structures having other inner layers that provide structure or other properties in the final article. For example, the skin layers can be selected to have an additional desirable properties such as toughness, printability and the like are advantageously employed on either side of the core component to provide films suitable for packaging and many other applications where their combinations of low moisture barrier, low CO₂ gas barrier, physical properties and low cost will be well suited. In another aspect of the present disclosure, tie layers can be used with the multilayer film or sheet structures according to the present disclosure.

9. Multilayer Film

The present multilayer film can be a stand-alone film or can be a component of another film, a laminate, a sheet, or an article.

The present multilayer film may be used as films or sheets for various known film or sheet applications or as layers in thicker structures and to maintain light weight and low costs.

When employed in this way in a laminate structure or article with outer surface or skin layers and optional other inner layers, the present multilayer film can be used to provide at least 5 volume % of a desirable film or sheet, including in the form of a profile, tube, parison or other laminate article, the balance of which is made up by up to 95 volume % of additional outer surface or skin layers and/or inner layers.

In an embodiment, the present multilayer film provides at least 10 volume %, or at least 15 volume %, or at least 20 volume %, or at least 25 volume %, or at least 30 volume % of a laminate article.

In an embodiment, the present multilayer film provides up to 100 volume %, or less than 80 volume %, or less than 70 volume %, or less than 60 volume %, or less than 50 volume %.

In an embodiment, the multilayer film includes the core component and skin layers. The core component is from 90% to 95% of the total multilayer film volume and the skin layers are from 5% to 10% of the total multilayer film volume. Each skin layer includes a first LLDPE, a second LLDPE (different than the first LLDPE), and a composite that is an LLDPE (a third LLDPE different than the first LLDPE and the second LLDPE) and CaCO₃. Layer A has a width from 1.0 mm to 10.0 mm and includes a first LLDPE, a second LLDPE (different than the first LLDPE), and a composite that is an LLDPE (a third LLDPE different than the first LLDPE and the second LLDPE) and CaCO₃. Layer B has a width from 1.0 mm to 10.0 mm and includes a polyether block amide. The multilayer film has one, some, or all of the following properties:

(i) a water vapor transmission rate (WVTR) from 50, or 100, or 150, or 200, or 250 to 300, 0r 350, or 400, or 450, or 500 g-mil/m²/24 hour; and

(ii) a carbon dioxide (CO₂) transmission rate from 50,000, or 100,00, or 150,000 to 200,000, or 250,000, or 300,000 cc-mil/m²/24 hour/atm.

In an embodiment, the multilayer film (with skin layers) has an overall thickness from 2.5, or 5, or 7.5, or 10, or 12.5 to 20, or 25, or 37.5, or 50, or 75, or 125, or 200, or 250 micrometers (0.1 mil, or 0.2 mil, or 0.3 mil, or 0.4 mil, or 0.5 mil, to 0.8 mil, or 1.0 mil, or 1.5 mil, or 2.0 mil, or 3.0 mil, or 5.0 mil, or 7.9 mil, or 10.0 mil).

10. Article

The present disclosure provides an article. In an embodiment, the present multilayer film is a component of an article. Nonlimiting examples of suitable articles include laminate structures, die formed articles, thermoformed articles, vacuum formed articles, or pressure formed articles. Other articles include tubes, parisons, and blow molded articles such as bottles or other containers.

In an embodiment, the article is a container. The container includes the present multilayer film. The article also includes a produce item located in the container. The present multilayer film contacts the produce item. Nonlimiting examples of suitable containers include flexible containers such as a bag, a pouch composed of the present multilayer film, or a substrate (such as a tray or bowl) around/upon which the present multilayer film is wrapped. A “produce item,” as used herein, is an agricultural food product that is a fruit, a vegetable, a grain, and combinations thereof.

In an embodiment, the produce item is a fresh produce item. A “fresh produce item,” as used herein, is the produce item in the same state, or in substantially the same state, as when the produce item was harvested. The harvested produce item may or may not be subjected to a wash procedure or a cleaning procedure before being placed in the container.

### Test Methods

Density is measured in accordance with ASTM D 792.

Melt flow rate (MFR) is measured I accordance with ASTM D 1238, Condition 280° C./2.16 kg (g/10 minutes).

Melt index (MI) is measured in accordance with ASTM D 1238, Condition 190° C./2.16 kg (g/10 minutes).

Moisture permeability is a normalized calculation performed by first measuring Water Vapor Transmission Rate (WVTR) for a given film thickness. WVTR is measured at 38° C., 100% relative humidity and 1 atm pressure are measured with a MOCON Permatran-W 3/31. The instrument is calibrated with National Institute of Standards and Technology certified 25 μm-thick polyester film of known water vapor transport characteristics. The specimens are prepared and the WVTR is performed according to ASTM F1249. Units for WVTR are g-mil/meter² (m²)/24 hour (hr).

CO₂ permeability is a normalized calculation performed by first measuring CO₂ Transmission Rate (CO₂TR) for a given film thickness. CO₂TR is measured at 23° C., 0% relative humidity and 1 atm pressure are measured with a MOCON PERMATRAN-C Model 4/41. The instrument is calibrated with National Institute of Standards and Technology certified Mylar film of known CO₂ transport characteristics. The specimens are prepared and the CO₂TR is performed according to ASTM F2476. Units for CO₂TR are ccₛₜₚ-mil/m²/24 hr/atmosphere (atm).

Some embodiments of the present disclosure will now be described in detail in the following Examples.

### Examples

Table 2 summarizes the layer A materials giving trade name, density, cyclic unit, weight percentage of the cyclic units, control film.

TABLE 2
Layer A Components

| | | | MFR | |
|---|---|---|---|---|
| | Trade | Density | (g/10 min) @ | |
| | Name | (g/cc) | 280° C./2.16 kg | WVTR |
| LLDPE | DOWLEX | 0.917 | 25.0 | ~25 |
| | 2517 | | | |
| LLDPE | DOWLEX | 0.919 | 6.0 | ~24.5 |
| | 2035 | | | |
| LLDPE | AMPACET | — | — | — |
| w/70 wt % | 104466 | | | |
| CaCO₃ | | | | |

Table 3 summarizes the layer B materials, Trade name, and control film control film Water Vapor Transmission Rate (WVTR) values.

TABLE 3
Layer B Components

| | | MFR | | Moisture |
|---|---|---|---|---|
| | Trade | (g/10 min) @ | Density | permeability |
| | Name | 190° C./2.16 kg | (g/cc) | (g-mil/m2/day) |
| Polyether | PEBAX | 10 | 1.01 | 79,844** |
| block amide | 2533 | | | |
| EVA | ELVAX | 2.5 | 0.94 | 85 |
| | 3150 | | | |

**Yiyi Shangguan, “Intrinsic Properties of Poly(Ether-B-Amide) (Pebax ®1074) for Gas Permeation and Pervaporation”, Thesis - University of Waterloo, Canada, 2011.

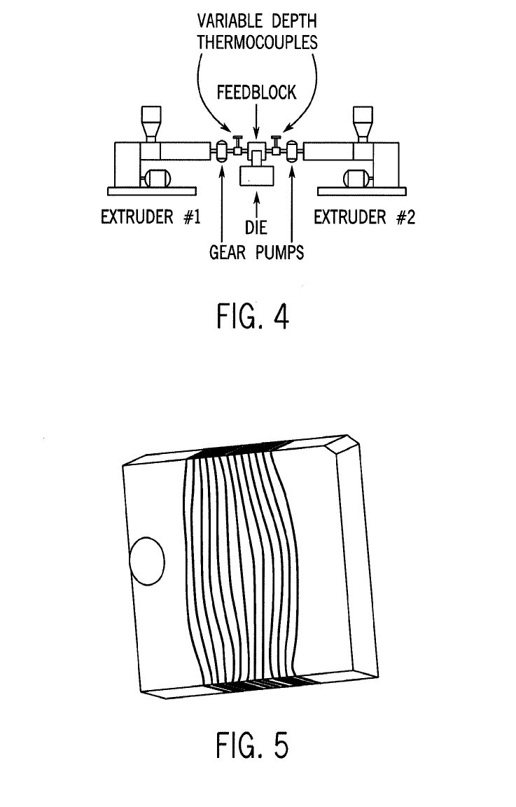

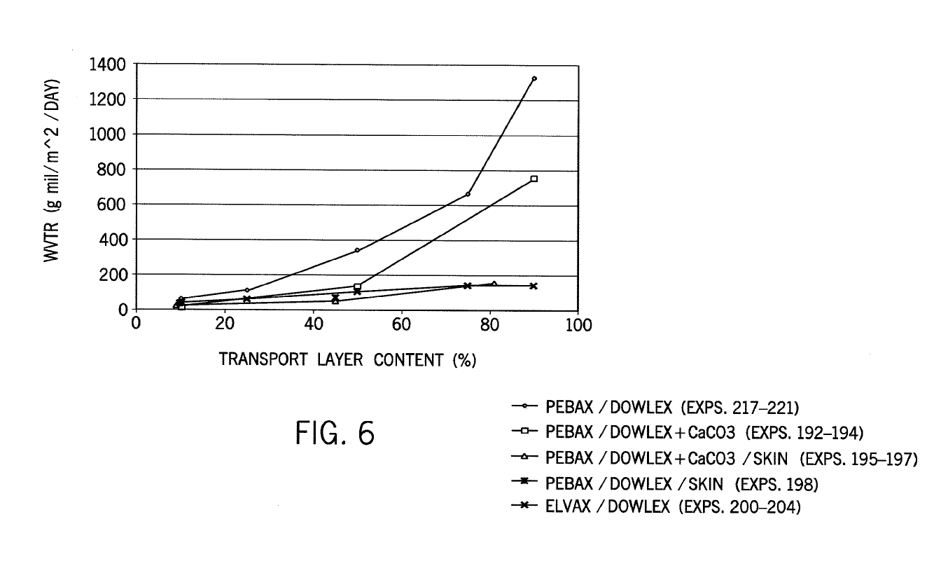

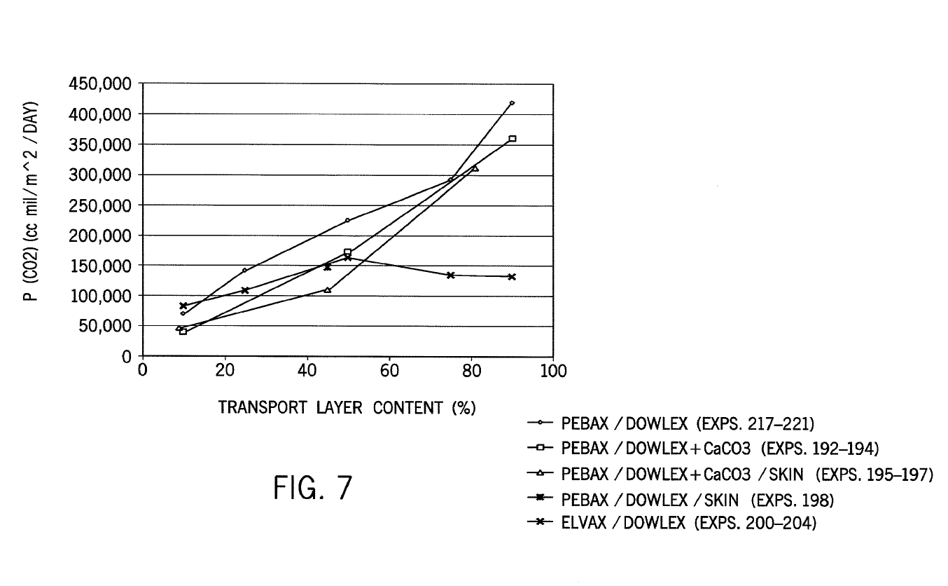

The materials in Table 2 and Table 3 are introduced into a co-extrusion device to produce striped multilayer structures. The cast co-extrusion line includes two 31.75 mm (1.25 inch) diameter, 24:1 L/D single screw extruders and a 25.4 mm (1.0 inch) diameter, 24:1 L/D single screw extruder. A schematic diagram of the extrusion line set-up is shown in FIG. 4. This simplified diagram shows only two of the three extruders that can be used in this system. The extruders feed individual gear pumps to ensure uniform flow of the polymer melts to the feedblock and dies. The gear pumps are attached to a feedblock by transfer lines that contain variable depth thermocouples to ensure consistent and uniform temperatures from the extruders. A feedblock is used to produce stripes of coextruded structures with 27 layers. The width of each stripe (layer A and layer B) is about 7.6 mm. Coextruded striped structures are made using the same material in each extruder with different colored pigments added to each to demonstrate the striped structure (as opposed to stacked structure) of the multilayer film as shown in FIG. 5.

Table 4 below shows the properties and structure of striped multilayer films produced as described above.

TABLE 4
Multilayer Film with Striped Core Component - Water and CO₂ permeability

| | | | | Thickness | Ratio | | |
|---|---|---|---|---|---|---|---|
| Experiments | A Layer | B Layer | Skin Material | (mils) | (A:B:skin) | CO₂TR | WVTR |
| 217 | 55% Dowlex 2517 + | Pebax 2533 | | 3 | 90/10 | 68,422 | 57 |
| | 45% Dowlex 2035 | | | | | | |
| 218 | 55% Dowlex 2517 + | Pebax 2533 | | 3 | 75/25 | 140,486 | 107 |
| | 45% Dowlex 2035 | | | | | | |
| 219 | 55% Dowlex 2517 + | Pebax 2533 | | 3 | 50/50 | 224,258 | 338 |
| | 45% Dowlex 2035 | | | | | | |
| 220 | 55% Dowlex 2517 + | Pebax 2533 | | 3 | 25/75 | 291,490 | 664 |
| | 45% Dowlex 2035 | | | | | | |
| 221 | 55% Dowlex 2517 + | Pebax 2533 | | 3 | 10/90 | 418,176 | 1,326 |
| | 45% Dowlex 2035 | | | | | | |
| 192* | 67% Ampacet Product #6 | Pebax 2533 | | | 90:10 | 39,532 | 20 |
| | (104466) + 18% Dowlex | | | | | | |
| | 2517 + 15% Dowlex 2035 | | | | | | |
| 193 | 67% Ampacet Product #6 | Pebax 2533 | | | 50:50 | 171,277 | 133 |
| | (104466) + 18% Dowlex | | | | | | |
| | 2517 + 15% Dowlex 2035 | | | | | | |
| 194 | 67% Ampacet Product #6 | Pebax 2533 | | | 10:90 | 359,607 | 754 |
| | (104466) + 18% Dowlex | | | | | | |
| | 2517 + 15% Dowlex 2035 | | | | | | |
| 195* | 67% Ampacet Product #6 | Pebax 2533 | 67% Ampacet Product #6 | | 81:9:10 | 46,968 | 26 |
| | (104466) + 18% Dowlex | | (104466) + 18% Dowlex | | | | |
| | 2517 + 15% Dowlex 2035 | | 2517 + 15% Dowlex 2035 | | | | |
| 196 | 67% Ampacet Product #6 | Pebax 2533 | 67% Ampacet Product #6 | | 45:45:10 | 110,505 | 54 |
| | (104466) + 18% Dowlex | | (104466) + 18% Dowlex | | | | |
| | 2517 + 15% Dowlex 2035 | | 2517 + 15% Dowlex 2035 | | | | |
| 197 | 67% Ampacet Product #6 | Pebax 2533 | 67% Ampacet Product #6 | | 9:81:10 | 312,656 | 157 |
| | (104466) + 18% Dowlex | | (104466) + 18% Dowlex | | | | |
| | 2517 + 15% Dowlex 2035 | | 2517 + 15% Dowlex 2035 | | | | |
| 198 | 55% Dowlex 2517 + | Pebax 2533 | 67% Ampacet Product #6 | | 45:45:10 | 146,744 | 64 |
| | 45% Dowlex 2035 | | (104466) + 18% Dowlex | | | | |
| | | | 2517 + 15% Dowlex 2035 | | | | |
| 199 | 55% Dowlex 2517 + | Pebax 2533 | 67% Ampacet Product #6 | | 45:45:10 | 150,848 | 64 |
| | 45% Dowlex 2035 | | (104466) + 33% Pebax | | | | |
| 200* | Dowlex 2247 | Elvax 3150 | | | 90:10 | 82,011 | 36 |
| 201 | Dowlex 2247 | Elvax 3150 | | | 75:25 | 107,600 | 58 |
| 202 | Dowlex 2247 | Elvax 3150 | | | 50:50 | 162,512 | 101 |
| 203 | Dowlex 2247 | Elvax 3150 | | | 25:75 | 133,281 | 142 |
| 204 | Dowlex 2247 | Elvax 3150 | | | 10:90 | 130,784 | 141 |

*comparative sample

Applicant discovered that a multilayer film with a core component having stripes of alternating layer A (film layer) and layer B (transport layer) exhibits an unexpected increase in CO₂TR, while maintaining effective WVTR. The permeability (WVTR and CO₂TR) for packaging utilizing the present multilayer film can be selectively controlled and tailored to the biological variation for a given produce item (fruit or vegetables) for the benefit of extended shelf life.

It is specifically intended that the present disclosure not be limited to the embodiments and illustrations contained herein, but include modified forms of those embodiments including portions of the embodiments and combinations of elements of different embodiments as come within the scope of the following claims.

1. A multilayer film comprising:
a core component comprising from 10 to 50,000 alternating stripes of a layer A and a layer B;
layer A having a width from 10 μm to 10 mm and comprising a film material;
layer B having a width from 10 μm to 10 mm and comprising a transport material;
wherein the core component has a CO₂ transmission rate (CO₂TR) from 50,000 to 300,000 cc-mil/m²/24 hour/atm and water transmission rate (WVTR) from 50 to 500 g-mil/m²/24 hour.

2. The multilayer film of claim 1 wherein the film material of layer A is a polymer selected from the group consisting of an ethylene-based polymer, a composite of an ethylene-based polymer and a particulate filler material, an ethylene acetate polymer, and combinations thereof.

3. The multilayer film of claim 1 wherein the film material of layer A comprises a first linear low density polyethylene (LLDPE) and a second linear low density polyethylene (LLDPE).

4. The multilayer film of claim 1 wherein the film material of layer A comprises a blend of (i) a composite of an an ethylene-based polymer and a particulate filler material, and (ii) at least one linear low density polyethylene (LLDPE).

5. The multilayer film of claim 1 wherein the film material of layer A comprises a blend of (i) a composite of an ethylene-based polymer and a particulate filler material, (ii) a first linear low density polyethylene (LLDPE), and (iii) a second LLDPE.

6. The multilayer film of claim 1 wherein the transport material of layer B is a polymer selected from the group consisting of a block polyether amide, an ethylene vinyl acetate polymer, and combinations thereof.

7. The multilayer film of claim 1 wherein the film material of layer A comprises a linear low density polyethylene (LLDPE) and the transport material of layer B comprises a block polyether amide.

8. The multilayer film of claim 1 wherein the volume ratio of layer A to layer B is from 85:15 to 10:90.

9. The multilayer film of claim 1 wherein the core component comprises from 20 to 200 alternating layers of layer A and layer B.

10. The multilayer film of claim 1 comprising at least one skin layer.

11. The multilayer film of claim 10 wherein the skin layer comprises a blend of (i) a composite of an ethylene-based polymer and a particulate filler material, (ii) a first linear low density polyethylene, and a second linear low density polyethylene.

12. The multilayer film of claim 11 wherein the core component comprises from 10 to 50,000 alternating stripes of a layer A, layer B, and a layer C;
layer C having a width from 10 μm to 10 mm and comprising a tie material.

13. An article comprising the multilayer film of claim 12.
